(19) United States
(12) Patent Application Publication
(10) Pub. No.: US 2003/0039755 A1
(43) Pub. Date: Feb. 27, 2003

(54) Coating method for improving oxidation and corrosion resistance of stainless steels

(76) Inventors: Olga Spaldon-Stewart, Des Plaines, IL (US); Robert J. Remick, Bolingbrook, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 09/932,633

(22) Filed: Aug. 17, 2001

(51) Int. Cl. B05D 3/02

(52) U.S. Cl. 427/376.1

(57) ABSTRACT

A method for improving the oxidation and corrosion resistance of stainless steels used in high temperature gaseous and/or molten salt environments in which a protective coating is applied to the stainless steel. The coating is applied by forming a mixture of an aqueous solution of at least one metal salt and polyethylene glycol and applying the mixture to a stainless steel substrate. The coated stainless steel substrate is heated to a temperature suitable for evaporating water, resulting in evaporation of water from the mixture disposed on the stainless steel substrate and formation of a layer of the polyethylene glycol and the metal salt. The stainless steel substrate is then heated to a temperature suitable for vaporizing the polyethylene glycol, resulting in vaporization of the polyethylene glycol and decomposition of the at least one metal salt into nanometer-size metal oxide particles. The metal oxide particles are then sintered, forming a dense metal oxide layer on the stainless steel substrate.

### BACKGROUND OF THE INVENTION

1. Field of the Invention

This invention relates to a method for improving the oxidation and corrosion resistance of stainless steels by application of a protective coating thereto. More particularly, this invention relates to a method for applying a protective coating to a stainless steel substrate in which nanometer-size metal oxide particles are collected on the surface of the stainless steel substrate and transformed into a dense layer.

2. Description of Related Art

Stainless steels, due to their relatively low cost compared to superalloys, are often the preferred materials for high temperature service in air and combustion devices and in molten salt environments such as is present in molten carbonate fuel cells. Stainless steels react with oxygen-containing gases, such as air or steam, at high temperatures to form a protective scale of chromium oxide. However, in the presence of molten salts, the surface layer of the stainless steel is attacked by the molten salt resulting in the leaching of all salt-soluble compounds from the scale, leaving behind a protective coating of insoluble scale. In the case of lithium-containing molten carbonate salts, the insoluble protective oxide layer is lithium ferrite, LiFeO₂.

The utility of a stainless steel composition in a particular application is frequently governed by the rate at which the reactive components of the gas or molten salt penetrate the protective scale to attack the underlying metal. Rapid development of a protective surface scale that slows or inhibits further scale growth is the key to extended life.

The speed with which the protective scale forms is related to the amount of protective scale-forming metal in the stainless steel formulation. For example, high resistance to oxidation is usually imparted to stainless steel by the formation of a chromium oxide, Cr₂O₃, layer on or proximate the surface of the stainless steel. As the stainless steel is heated to moderately high temperatures, the surface begins to oxidize. Chromium diffuses to the surface, forming a protective layer. As the percentage of chromium present in the stainless steel increases, the speed at which the protective layer forms also increases, resulting in thinner oxide scale layers forming on the stainless steel surface. In applications such as gas burners and heat exchangers, where rapid thermal cycling between room temperature and the combustion temperature is required, the higher chromium content stainless steels, such as 310 SS have longer service life than the lower chromium content stainless steels, such as 304 SS and 347 SS. This is because the formation of the protective layer takes longer in the lower chromium content materials, as a result of which a thicker surface scale develops in these materials. However, a thicker scale is more likely to break off during thermal cycling due to the mismatch in the thermal expansion coefficients between the scale and the underlying stainless steel alloy.

Unfortunately, higher chromium content stainless steels are more difficult to form and machine and are substantially higher in cost than lower chromium content stainless steels. Thus the need for a method for building a protective chromium layer on low cost stainless steels, such as 304 SS, that is present from the outset of service life and which inhibits, from the outset, the formation of a thick oxide scale is apparent.

In a similar fashion, the surface of 300 series stainless steels in contact with molten alkali carbonate in an oxidizing environment is processed by chemical attack to form a layer of lithiated iron oxide having the approximate formula LiFeO₂. This lithiated iron oxide is insoluble in molten alkali carbonates and, thus, protects the underlying metal from further attack. However, it takes time to build up this protective layer, during which time the nickel and chromium metals that are also part of the surface of the alloy are leached from the metal to form a thick surface scale. Here again, it will be apparent that a method for applying a protective coating of lithiated iron oxide to the surface of the stainless steel prior to placing it in service is desirable.

Numerous methods for applying a protective coating onto a substrate, including stainless steel substrates, are known. For example, U.S. Pat. No. 6,177,201 to Wallace et al. teaches a porcelain enamel coating suitable for use on high-carbon content, heat-rolled sheet steel, which coating includes a ground coat layer comprising a soft ground coat frit having nickel oxide dispersed substantially uniformly throughout for coating directly onto the steel and a cover coat layer. U.S. Pat. No. 6,165,257 to Heimann et al. teaches compositions and methods for forming a mineralized coating or film upon at least a portion of a metal-containing surface. By the term “mineralized”, it is meant a composition containing at least one member selected from the group consisting of oxygenated cations and anions wherein at least a portion of the mineralized composition corresponds to an amorphous phase, and inorganic complex oxide crystals and mixtures thereof. The mineralized coating is formed from precursors, that is, combinations of materials which interact to form the mineralized layer as well as intermediate products that interact further to form the mineralized layer, examples of which include buffers such as silicate buffers and carbonate buffers, silicates and silica. The precursors of the mineralized layer are added to a suitable carrier which, in accordance with one embodiment, includes unsaturated polyglycols. The carrier together with the precursors is then applied to the metal-containing surface. U.S. Pat. No. 5,874,374 to Ong teaches a method for producing engineered materials, such as thin films and other structural masses, from salt/polymer aqueous solutions in which an aqueous continuous phase having at least one metal cation salt is mixed with a hydrophilic organic polymeric disperse phase so as to form a metal cation/polymer gel. The metal cation/polymer gel is then treated to form a structural mass precursor, which structural mass precursor is then heated, resulting in formation of a structural mass having predetermined characteristics based upon the intended application of the structural mass. And, U.S. Pat. No. 5,599,385 to Czech et al. teaches a protective coating resistant to corrosion consisting essentially of 25-40% by weight nickel, 25-32% by weight chromium, 7-9% by weight aluminum, 0.5-2.0% by weight silicon, 0.3-1.0% by weight of at least one reactive element of the rare earths and, selectively, from 0-15% by weight of at least one of rhenium, platinum, palladium, zirconium, manganese, tungsten, titanium, molybdenum, niobium, iron, hafnium, and tantalum, and at least 5% by weight cobalt. The coating is applied on a nickel-based or cobalt-based superalloy substrate.

Extensive prior art also exists for coating stainless steel and superalloys with thermal barriers. The thermal barriers limit the rate of oxidation of the metals heated in air or combustion environments by preventing rapid heat transfer to the metal and by reflecting infrared radiation. A typical thermal barrier coating that can be applied by a variety of flame and plasma spraying methods is stabilized zirconium oxide. However, thermal barrier coatings, because they limit heat transfer, are not suitable for coating heat transfer surfaces such as are found in furnaces, boilers and other combustion devices. Chromium oxide and lithium iron oxide coatings, on the other hand, are excellent heat conductors and also are good p-type semiconductors. This makes them excellent coatings for use on heat exchanger surfaces and on current collectors in high temperature fuel cells.

### SUMMARY OF THE INVENTION

It is one object of this invention to provide a method for increasing the oxidation and corrosion resistance and extending the life of stainless steels used in high temperature gaseous or molten salt environments.

It is one object of this invention to provide a method for coating stainless steels so as to increase the oxidation and corrosion resistance of the stainless steels in high temperature oxidation and molten salt environments.

These and other objects of this invention are addressed by a method for coating stainless steel in which a mixture of an aqueous solution of at least one metal salt and polyethylene glycol is formed and then applied to a stainless steel substrate. The stainless steel substrate is heated to a temperature suitable for evaporating water, resulting in evaporation of water from the mixture disposed on the stainless steel substrate and formation of a gel-like layer of the polyethylene glycol and the metal salt. If the stainless steel substrate surface is irregular, it can be heated prior to applying the coating to rapidly evaporate the water and immediately form the gel-like surface layer. The stainless steel substrate is then heated to a temperature suitable for vaporizing the polyethylene glycol, up to about 500° C., resulting in vaporization of the polyethylene glycol and decomposition of the at least one metal salt into nanometer-size metal oxide particles. As used herein, the term “nanometer-size” particles refers to particles having a diameter in the range of about 1 to about 100 nanometers. The oxide particles thus collected on the surface of the substrate are then sintered to form a dense layer. It should be noted that nanometer-size particles sinter at significantly lower temperatures than larger, such as micron-size particles of the same material.

### BRIEF DESCRIPTION OF THE DRAWINGS

These and other objects and features of this invention will be better understood from the following detailed description taken in conjunction with the drawings wherein:

FIG. 1 is a diagram showing the effect of thermal cycling on four stainless steel coupons coated in accordance with the method of this invention and one uncoated stainless steel coupon.

### DETAILED DESCRIPTION OF THE PRESENTLY PREFERRED EMBODIMENTS

This invention is a method for depositing a dense adherent layer of metal oxide on the surface of stainless steel for the purpose of protecting the underlying stainless steel from rapid oxidation by air or corrosion by molten salts in a high temperature environment. The process uses an aqueous solution of a metal salt and polyethylene glycol. The metal salt is preferably selected from the group consisting of chlorides, carbonates, hydroxides, isopropoxides, nitrates, acetates, epoxides, oxalates, and mixtures thereof. The metal is preferably selected from the group consisting of Group IA, IIA, IIIA, IVA, VA, VIA, IB, IIB, IIIB, IVB, VB, VIB, VIIB and VIII of the Periodic Table, lanthanides, actinides and mixtures thereof. Although it will be apparent to those skilled in the art that there are a number of ways in which the mixture can be applied to the stainless steel substrate, preferably, the mixture is sprayed onto the stainless steel substrate using a suitable paint spraying device. The substrate is then heated to evaporate the water, leaving the metal salt dissolved in a gel-like layer of polyethylene glycol. The stainless steel substrate coated with the metal salt/polyethylene glycol gel-like layer is then heated to temperatures up to about 500° C. to vaporize the polyethylene glycol and decompose the metal salt into nanometer-size metal oxide particles. These metal oxide particles are collected on the surface of the stainless steel substrate where they are sintered to form a dense layer.

In accordance with one preferred embodiment of this invention, the metal salt is iron III nitrate, resulting in the formation of iron oxide particles on the stainless steel substrate. Use of iron III nitrate as the metal salt plus stoichiometric amounts of lithium nitrate produces an adherent layer of lithium ferrite on the surface of 300 series stainless steels, rendering them highly resistant to attack by molten alkali carbonates. In accordance with another preferred embodiment of this invention, the metal salt is chromium acetate hydroxide. Use of chromium acetate hydroxide as the metal salt produces an adherent layer of chromium oxide, Cr₂O₃, on the surface of 300 series stainless steels that greatly slows oxidation of these metals in a high temperature oxidizing environment.

The method for coating stainless steel in accordance with one embodiment of this invention comprises mixing an aqueous continuous phase comprising at least one metal salt with a hydrophilic organic polymeric disperse phase to form a metal cation/polymer gel. The metal cation/polymer gel is applied to the stainless steel substrate. The coated stainless steel substrate is then heated to a temperature suitable for evaporating water, resulting in evaporation of water from the metal cation/polymer gel and formation of a polymer gel/metal salt coated stainless steel substrate comprising a layer of the polymer gel and the at least one metal salt. The polymer gel/metal salt coated stainless steel substrate is then heated to a temperature suitable for vaporizing the polymer gel, resulting in vaporization of the polymer gel and decomposition of the at least one metal salt into nanometer-size metal oxide particles.

### EXAMPLE

In this example, chromium hydroxy-acetate was used to produce a coating in accordance with one embodiment of the method of this invention. 5 grams of polyethylene glycol having an average molecular weight of 4500 were mixed with 46 grams of deionized water. To this mixture, 8 drops of Triton X-100 surfactant were added followed by the slow addition of 5 grams of chromium III acetate hydroxide, (CH₃CO₂)₇Cr₃(OH)₂. A one-inch square coupon of 304S stainless steel was prepared and cleaned with ethanol. The coupon was heated to a temperature of about 160-170° C. by placing it on an electric hot plate heated to a temperature of about 180° C. A uniform layer of the mixture was sprayed onto one side of the coupon using an airbrush. This layer had the initial form of a green gel. (Because chromium salts are toxic and because there are some hazardous fumes produced, this step must be performed in a fume hood.) Evaporation of the water cools the sample. The coupon comprising the layer of green gel was then reheated, again to a temperature of about 170° C., resulting in a change in the layer from a shiny emerald green to a very uniform powdery light green. Only one layer was required. The coupon was then removed from the hot plate and allowed to cool to room temperature. The process was then repeated on the opposite side of the coupon. After allowing the completely coated coupon to cool, it was weighed. The sample coupon was then ready for thermal testing.

Tests were conducted using 304S stainless steel coupons coated as discussed hereinabove. Four coated coupons were placed into a combustion boat along with one uncoated control coupon and introduced into the hot zone of a tube furnace. After heating for two hours in the air at a temperature of 980° C., the combustion boat was pushed through to the unheated end of the tube and rapidly cooled to room temperature. Each coupon was brushed with a cosmetic brush to remove loose flakes of oxide. The brushed coupons were weighed to the nearest 0.1 mg. The coupons were then replaced in the combustion boat and reinserted into the hot zone of the tube furnace. This cycle was repeated 12 times.

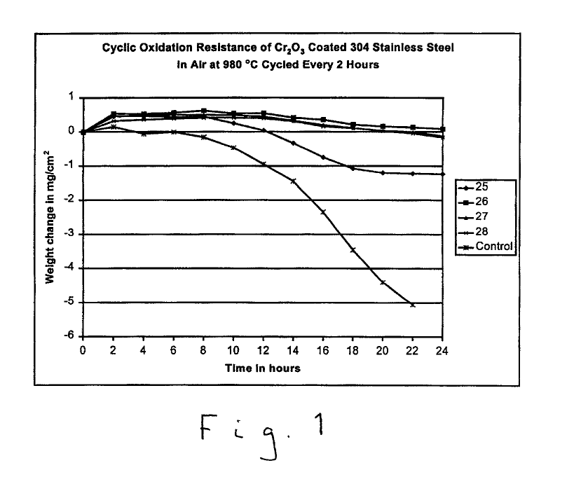

FIG. 1 is a plot of the weight loss in mg/cm² as a function of hot time for each of the five coupons, four coated coupons numbered 25-28 and one control sample. The total surface area, including the edges, of each coupon was approximately 14.4 cm². Three of the coupons, Nos. 26, 27 and 28 showed excellent oxidation resistance compared to the uncoated control coupon. Coated coupon No. 25 showed higher weight loss than the other coated coupons. However, close examination of this coupon indicated that the edges of the coupon had not received the full benefit of the coating process, probably as a result of the directional nature of the spray.

As previously stated, the four coated coupons were subjected to 12 thermal cycles, the first of which also was used to decompose the polyethylene glycol (PEG). Each thermal cycle consisted of a two-hour period at a temperature of about 980° C. followed by a 30-minute period for cooling to room temperature. The uncoated control coupon was not present during the first thermal cycle and, thus, was subjected to only 11 thermal cycles. Table 1 summarizes the cumulative weight loss results for the five coupons.

TABLE 1
Weight Change of Coupons During Thermal Cycle Tests

| Sample | | Coating | Cumulative Weight |
|---|---|---|---|
| No. | Coating Type | Weight, mg | Change, mg |
| 25 | Chromium Salt + PEG | 31.7 | −17.9 |
| 26 | Chromium Salt + PEG | 45.9 | +1.3 |
| 27 | Chromium Salt + PEG | 45.5 | −1.7 |
| 28 | Chromium Salt + PEG | 23.4 | −2.2 |
| Control* | None | N.A. | −73.1 |

*subjected to only 11 thermal cycles

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for coating stainless steel comprising the steps of:
forming a mixture of an aqueous solution of at least one metal salt and polyethylene glycol;
applying said mixture to a stainless steel substrate;
heating said stainless steel substrate to a temperature suitable for evaporating water, resulting in evaporation of water from said mixture disposed on said stainless steel substrate and forming a layer of said polyethylene glycol and said metal salt; and
heating said stainless steel substrate to a temperature suitable for vaporizing said polyethylene glycol, resulting in vaporization of said polyethylene glycol and decomposition of said at least one metal salt into metal oxide particles.

2. A method in accordance with claim 1, wherein said metal oxide particles are sintered, forming a dense layer.

3. A method in accordance with claim 1, wherein said metal oxide particles are nanometer-size particles.

4. A method in accordance with claim 1, wherein said at least one metal salt is iron III nitrate.

5. A method in accordance with claim 4, wherein said aqueous solution further comprises a stoichiometric amount of lithium nitrate.

6. A method in accordance with claim 1, wherein said at least one metal salt is chromium acetate hydroxide.

7. A method in accordance with claim 1, wherein said metal oxide particles comprise chromium oxide.

8. A method in accordance with claim 1, wherein said metal oxide particles comprise iron oxide.

9. A method in accordance with claim 1, wherein said metal oxide particles comprise lithium iron oxide.

10. A method in accordance with claim 1, wherein said at least one metal salt is selected from the group consisting of chlorides, carbonates, hydroxides, isopropoxides, nitrates, acetates, epoxides, oxalates, and mixtures thereof.

11. A method in accordance with claim 1, wherein said metal is selected from the group consisting of Group IA, IIA, IIIA, IVA, VA, VIA, IB, IIB, IIIB, IVB, VB, VIB, VIIB and VIII of the Periodic Table, lanthanides, actinides and mixtures thereof.

12. A method for coating stainless steel comprising the steps of:
mixing an aqueous continuous phase comprising at least one metal salt with a hydrophilic organic polymeric disperse phase, forming a metal cation/polymer gel;
applying said metal cation/polymer gel to a stainless steel substrate, forming a metal cation/polymer gel coated stainless steel substrate;
heating said metal cation/polymer gel coated stainless steel substrate to a temperature suitable for evaporating water, resulting in evaporation of water from said metal cation/polymer gel and formation of a polymer gel/metal salt coated stainless steel substrate comprising a layer of said polymer gel and said at least one metal salt; and
heating said polymer gel/metal salt coated stainless steel substrate to a temperature suitable for vaporizing said polymer gel, resulting in vaporization of said polymer gel and decomposition of said at least one metal salt into metal oxide particles.

13. A method in accordance with claim 12, wherein said at least one metal salt is selected from the group consisting of chlorides, carbonates, hydroxides, isopropoxides, nitrates, acetates, epoxides, oxalates, and mixtures thereof.

14. A method in accordance with claim 12, wherein said metal is selected from the group consisting of Group IA, IIA, IIIA, IVA, VA, VIA, IB, IIB, IIIB, IVB, VB, VIB, VIIB and VIII of the Periodic Table, lanthanides, actinides and mixtures thereof.

15. A method in accordance with claim 12, wherein said metal oxide particles are sintered, forming a dense layer.

16. A method in accordance with claim 12, wherein said metal oxide particles are nanometer size particles.

17. A method in accordance with claim 12, wherein said hydrophilic organic polymeric disperse phase comprises an organic material selected from the group consisting of polymers, carbohydrates, proteins derived from animal protein gelatins and mixtures thereof.

18. A method in accordance with claim 17, wherein said organic material is polyethylene glycol.

19. A method in accordance with claim 13, wherein said at least one metal salt is iron III nitrate.

20. A method in accordance with claim 19, wherein said aqueous continuous phase further comprises a stoichiometric amount of lithium nitrate.

21. A method in accordance with claim 13, wherein said at least one metal salt is chromium acetate hydroxide.

22. A method in accordance with claim 12, wherein said metal oxide particles comprise a metal oxide selected from the group consisting of iron oxide, lithium iron oxide, chromium oxide and mixtures thereof.
